(19) United States
(12) Patent Application Publication
(10) Pub. No.: US 2008/0168702 A1
(43) Pub. Date: Jul. 17, 2008

(54) INSECT TRAP

(75) Inventor: Syed Kamal H. Jaffrey, Watertown, MA (US)

Correspondence Address: WILMERHALE/BOSTON, 60 STATE STREET, BOSTON, MA, 02109, US

(73) Assignee: DELTA SEARCH LABS, INC., Cambridge, MA (US)

(21) Appl. No.: 11/927,111

(22) Filed: Oct. 29, 2007

Related U.S. Application Data
(60) Provisional application No. 60/863,279, filed on Oct. 27, 2006.

(51) Int. Cl. A01M 1/22; A01M 1/10

(52) U.S. Cl. 43/111; 43/118; 43/112

(57) ABSTRACT

An insect trap system including a housing having first and second opposing ends, the first opposing end defining an aperture, an insect attractant module configured to create an airborne attractant zone, a fan disposed and configured to draw air into the housing through the aperture, a gate configured to operate in a first state wherein airflow through the aperture is inhibited by the gate, and to operate in a second state wherein airflow through the aperture is not substantially inhibited by the gate, wherein the gate is maintained in the first state for a predetermined first time such that the airborne attractant zone is formed and the gate is maintained in the second state for a second predetermined time such that insects within a capture zone are compelled to enter the housing through the aperture, wherein the gate is configured to alternate between the first and second states.

### RELATED APPLICATIONS

This application claims the benefit of U.S. Provisional Application No. 60/863,279, filed Oct. 27, 2006, the contents of which are incorporated herein by reference.

### TECHNICAL FIELD

This invention generally relates to insect traps, and more particularly to an insect trap that alternates between an insect-attracting state and a capture state.

### BACKGROUND

Today, many types of biting insects, such as mosquitoes, carry and transmit diseases that can sicken and even kill bite victims. Typical diseases spread by biting insects include West Nile Virus, Eastern Equine Encephalitis, dengue fever, and malaria. For example, each year Mosquitoes transmit diseases to more than 700 million people, and are responsible for the deaths of 1 of every 17 people currently alive. Thus, it is desirable to control the population of biting insects in order to help prevent the spread of disease. One method of insect population control is to catch and/or kill biting insects using a trap.

### SUMMARY

An insect trap alternates between attracting insects by using one or more of various insect attractants, and sucking them into a housing where they are killed.

In general, in one aspect, an insect trap includes a housing having first and second opposing ends, the first opposing end defining an aperture, an insect attractant module configured to create an airborne attractant zone, a fan disposed and configured to draw air into the housing via the aperture, a gate configured to operate in a first state wherein airflow through the aperture is inhibited by the gate, and to operate in a second state wherein airflow through the aperture is not substantially inhibited by the gate, wherein the gate is maintained in the first state for a predetermined first time such that the airborne attractant zone is formed and the gate is maintained in the second state for a second predetermined time such that insects within a capture zone are compelled to enter the housing via the aperture, wherein the gate is configured to alternate between the first and second states.

Other embodiments include one or more of the following features. The trap housing is configured as a visual attractant for insects; the housing includes a trapping device, which is a net that catches insects when the gate is in the second state; the trapping device is an electrical discharge device that kills insects when the gate is in the second state; a funnel is disposed between the gate and the trapping device, and the air current through the narrow end of the funnel is strong enough to prevent insects from escaping from the trapping device or from the housing. The airborne attractant zone includes carbon dioxide and a lure; the carbon dioxide can be generated by catalytic combustion. The trap includes a processor that causes the insect trap to alternate between an attractant plume generation state and a capture state. In the former state, the fan is off, the gate is in the first state (in which it inhibits airflow through the aperture), and the attractant module generates an attractant plume. In the capture state, the fan is on, the gate is in the second state (i.e., not substantially inhibiting air flow into the aperture), and the attractant module can be either generating an attractant plume or not. The insect attractant module can include an ultrasonic generator, an electrostatic sound generator, or a laser.

An attractant zone can be placed entirely within a capture zone. Insects can be lured to rest and/or hover within a zone in which there is enough airflow to force the insects into a trap. More insects can be captured in a given time compared with prior techniques. A fan used within a trap can be operated periodically rather than continuously. Less power can be consumed when compared with prior techniques. Smaller batteries can be used to power the trap when compared with prior techniques. The portability of the device can be increased when compared with prior techniques. A larger/stronger fan can be used with a given battery (e.g., because the fan is operated periodically) when compared with prior techniques. The trap can be used at residential dwellings and/or commercial environments to reduce the population of insects. An attractant plume can be formed around a trap more efficiently when compared with prior techniques. Insects can be captured without a constant source of air current using, for example, a periodic air current. The trap can be operated without a fixed gate, or without a gate, and the insects captured by periodically turning the fan off and allowing the attractant module to attract insects, and then turning the fan on to force the attracted insects into the trap.

These and other capabilities of the invention, along with the invention itself, will be more fully understood after a review of the following figures, detailed description, and claims.

### BRIEF DESCRIPTION OF THE FIGURES

FIGS. 1A-1B are exemplary sectional diagrams of an insect trap.

FIGS. 2A-2B are exemplary cross-sectional views of the insect trap shown in FIGS. 1A-1B.

FIG. 3 is an exemplary block diagram of a control system of the insect trap show in FIGS. 1A-1B.

FIGS. 4A-4B are exemplary cross-sectional views of the insect trap shown in FIGS. 1A-1B.

FIG. 5 is an exemplary diagram of an attractant zone and a capture zone of the insect trap shown in FIGS. 1A and 1B.

FIG. 6 is an exemplary diagram showing operational states of the insect trap shown in FIGS. 1A-1B.

FIG. 7 is an exemplary block flow diagram of a process for luring and capturing insects using the insect trap shown in FIGS. 1A-1B.

### DETAILED DESCRIPTION

Embodiments of the invention provide techniques for capturing insects such as mosquitoes using a fan-assisted and attractant-assisted trap. The trap includes a housing forming an aperture, a fan, an attractant module, and a gate. The gate is operable in first and second states. In the first state, the gate inhibits (and possibly even prevents) insects from passing through the aperture. In the second state, the gate is actuated within the aperture, such that air and insects can pass through the aperture. The trap generates an attractant plume that is configured to attract insects towards the trap. The gate is operated in the first state for a predetermined amount of time prior being actuated to the second state. When the gate is actuated to the second state, the fan is actuated to an on position, thus drawing into the trap the insects converging near the aperture. The fan is de-actuated to an off position and the gate is de-actuated to the first state, and the process is repeated. Other embodiments are within the scope of the invention.

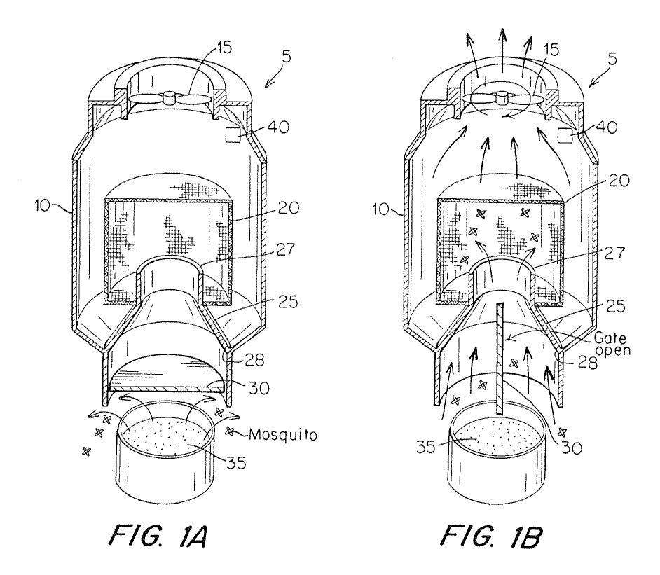

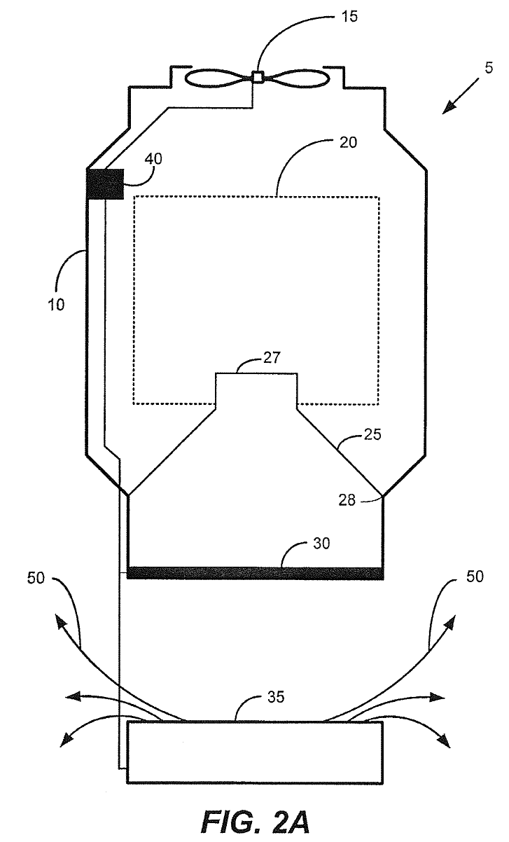

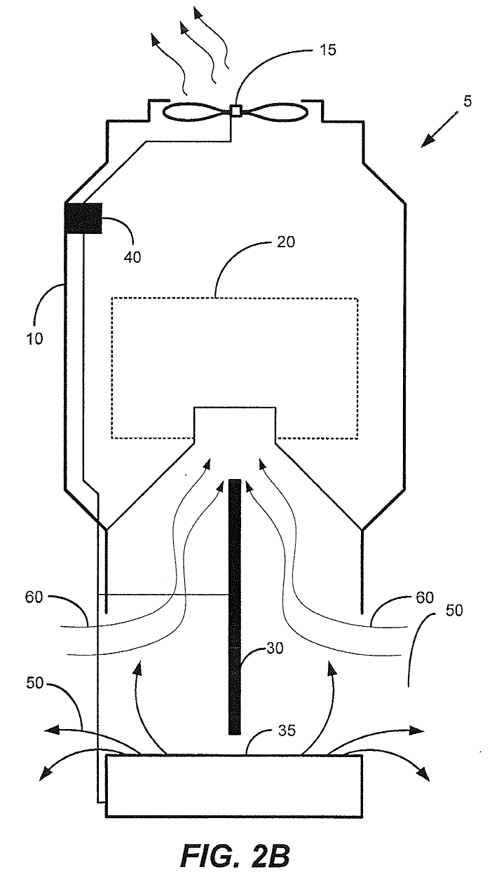

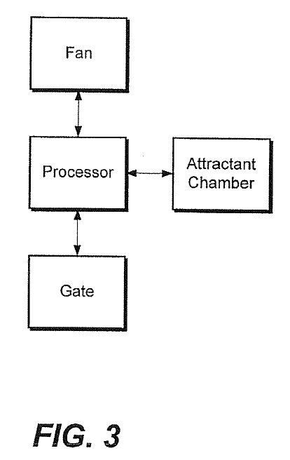

Referring to FIGS. 1A and 1B, an insect trap system 5 includes a housing 10, a fan unit 15, a trapping device 20, a funnel 25, a gate 30, an attractant chamber 35, and a processor 40. The housing 10, is generally cylindrical, though other configurations are possible (e.g., cubic). The housing 10 can be configured to be a visual attractant to insects (e.g., using various shapes and colors). The fan unit 15 is a fan and/or blower and is configured to draw air into the housing 10 via the funnel 25 and the trapping device 20, though other configurations are possible (e.g., the fan 15 can be disposed near the gate 30). The trapping device 20 is configured to catch and/or kill insects drawn into the housing 10. The trapping device 20 is, for example, a net and/or an electrical-discharge device. The funnel 25 is configured such that a speed of the air current through the funnel 25 increases as air is drawn into the funnel 25 (e.g., line 60 in FIG. 2B), The funnel 25 is configured such that the air current at an end 27 of the funnel 25 is sufficient to inhibit insects from escaping from the housing 10. The gate 30 is configured to inhibit access to/from the housing 10. The attractant chamber 35 is configured to generate an attractant plume that is configured to attract insects using carbon dioxide and a lure. The processor 40 is a controller configured control the operation of the fan 15, the gate 30, and the operation of the attractant chamber 35. The processor 40 is coupled to the fan 15, to the gate 30, and the attractant chamber (e.g., as shown in FIG. 3). Other configurations of the system 5 are possible (e.g., the system 5 can include a heating device configured to heat the attractant chamber 35, which can be controlled by the processor 40).

The system 5 is configured to attract/capture insects using chemical, visual, and physical characteristics. For example, the system 5 is configured to use chemical lures to attract insects towards the system 5 (as described more fully below). The system 5 can also be configured such that insects are visually attracted towards the system 5 (e.g., using specific colors, using specific shapes, using light emitted by the system 5, etc.), and the system 5 can be configured such that the physical design of the housing 10 enhances the effectiveness of the trapping process.

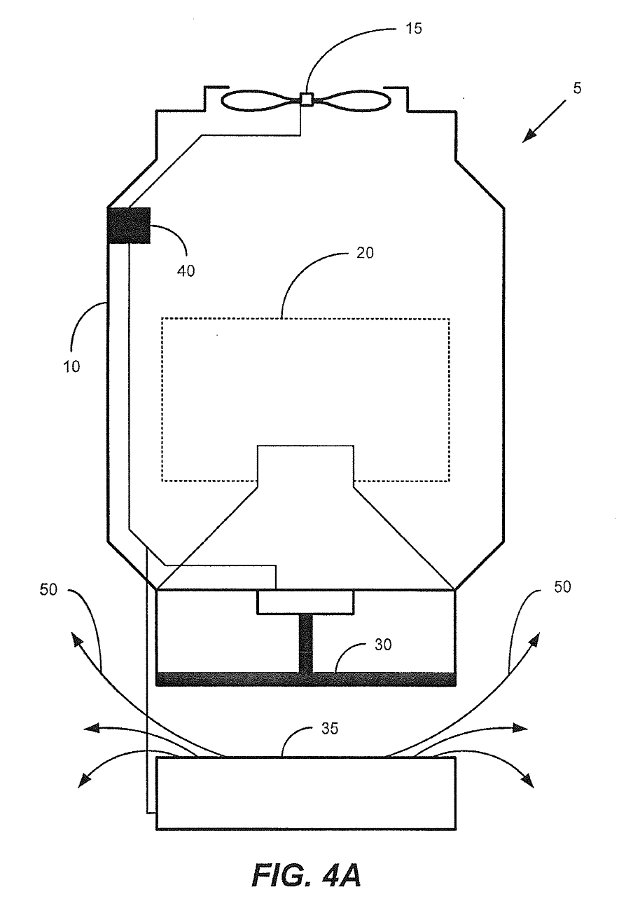

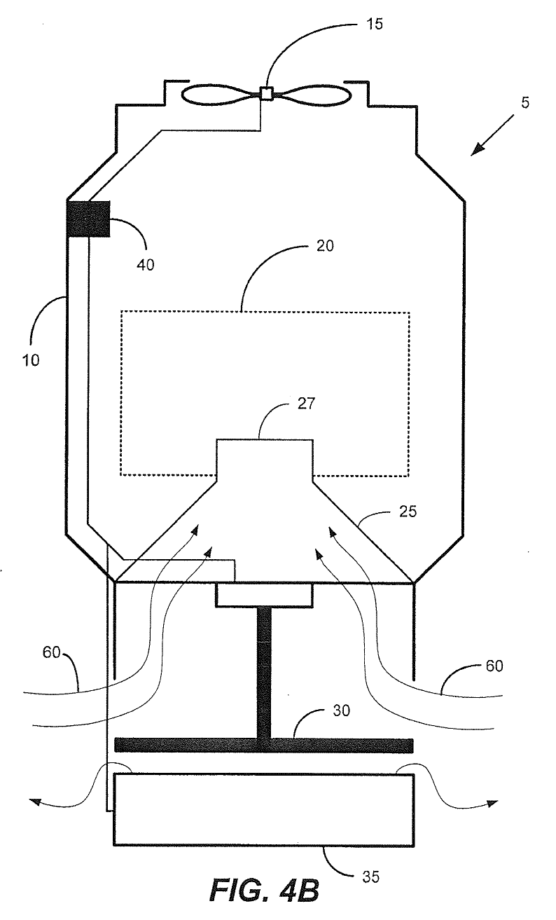

The gate 30 is configured be operable in multiple states. In a first state, (e.g., as shown in FIGS. 1A and 2A) the gate is configured such that insects contained within the housing 10 are inhibited from escaping from the housing 10 and such that air near the gate 35 is not substantially drawn into the housing 10. In a second state, (e.g., as shown in FIGS. 1B and 2B) the gate is configured such that the insects can be drawn into the housing 10, e.g., using the fan 15. For example, referring to FIGS. 2A and 2B, the gate 30 can be a door configured to mate with a corresponding aperture formed in the housing 10. When the gate 30 is in the first state, the door is configured to sealably engage the aperture and to inhibit insects contained within the housing 10 from escaping. When the gate 30 is in the second state, the door is actuated within from the aperture such that insects are preferably drawn into the housing 10 (e.g., by the fan 15). The configuration of the gate 30 can vary (e.g., as shown in FIGS. 4A and 4B). The fan 15, the funnel 25, and the gate 30 are configured such that the speed of the air current flowing through the funnel 25 increases as the air current flows from an end 28 of the funnel 25 to the end 27 of the funnel 25. The size of the ends 27 and 28, and a speed of the fan 15 can be adjusted to obtain a desired airflow rate (e.g., the end 28 can be configured such that the speed of the air current does not deter mosquitoes). Furthermore, while the gate 30 has been described as being operable in the first and second states, other states are possible.

The attractant chamber 35 is configured to generate/deliver an attractant plume (e.g., an attractant gradient) using a fuel and a lure. The attractant chamber is configured to receive one or more cartridges that, alone and/or in combination include the fuel used to generate carbon dioxide, and the lure. One or more fuels, and one or more lures can be used by the system 5. The attractant chamber 35 is configured to convert the fuel into carbon dioxide using a catalytic combustion process. For example, a catalytic conversion mesh (e.g., made of platinum, palladium, rhodium, cerium, iron manganese, and/or nickel) is heated using a heater (e.g., an electrical heater and/or a thermoelectric generator (e.g., using temperature gradients)). The heater is configured to heat the mesh such that when the fuel encounters (e.g., comes in contact with) the heated mesh, the fuel combusts, becomes exothermic, and carbon dioxide is produced. Efficiency of the catalytic conversion process can be regulated by adjusting the speed of the reaction process. The attractant chamber is also configured to release the lure, e.g., in an aerosol form, and/or a gaseous form. The attractant chamber can be configured to release the carbon-dioxide and/or the lure in a controlled manner, and/or in an uncontrolled manner. The lure can be, for example, Octenol, Lurex3®, brevicomin, codlelure, cue-lure, disparlure, dominicalure, eugenol, frontalin, gossyplure, grandlure, hexalure, ipsdienol, ipsenol, japonilure, lineatin, litlure, looplure, medlure, megatomoic acid, methyl eugenol, α-multistriatin, muscalure, orfralure, oryctalure, ostramone, siglure, sulcatol, trimedlure, trunc-call, lactic acid, a salt of lactic acid, and/or combinations thereof. The system 5 can be configured such that the fan 15 assists in dispersing the attractant plume.

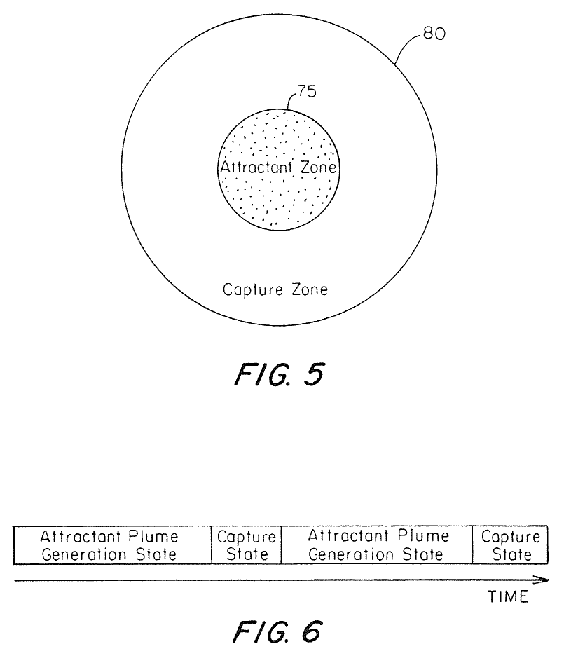

Referring to FIG. 5, the system 5 is configured to generate an attractant zone 75 that is within a capture zone 80. The attractant zone is a zone where mosquitoes are likely to converge due to the attractant plume generated by the system. The capture zone, is a zone where an airflow current (e.g., caused by operation of the fan 15) is sufficient to attract insects into a collection chamber (e.g., the area defined by the trapping device 20). A speed of the air current in the capture zone 80 (e.g., at the end 28 of the funnel 25) is preferably less than an air current speed that would force the insects into the collection chamber (e.g., some mosquitoes can be deterred if the air current speed is too high), although other configurations are possible (e.g., the air current speed can be sufficient to force insects into the collection chamber).

The processor 40 is configured to control the operation of the system 5. For example, the system 5 is configured to operate in an attractant plume generation state and a capture state. During the attractant plume generation state, the processor 40 is configured to de-actuate the fan to an off position, to de-actuate the gate 30 into the first state, and to cause the attractant chamber 35 to generate the attractant plume. During the capture state, the processor 40 is configured to actuate the fan to an on position, to actuate the gate 35 into the second state, and to optionally cause the attractant chamber 35 to generate the attractant plume (e.g., the attractant chamber can be configured to constantly generate an attractant plume, or be switched on and off). The processor 40 can be configured to actuate the fan 15 to the on position prior to actuating the gate 35 into the second state (e.g., to inhibit, and possibly prevent, previously captured insects from escaping). The system 5 is configured such that while the system 5 operates in the capture state, insects within the capture zone 80 are drawn into the trapping device 20 by the air current in the funnel 25. The processor 40 is configured to cycle the system 5 between the attractant plume generation state and the capture state. For example, referring to FIG. 6, the system 5 is operated in the attractant plume generation state for a predetermined amount of time (e.g., 1-3 minutes), during which time insects are preferably attracted to the attractant zone and the area surrounding the attractant zone. After operating in the attractant plume generation state, the system 5 is configured to operate in the capture state (e.g., for several seconds) thereby causing sufficient airflow to draw insects within the capture zone into the trapping device 20. The system 5 is configured to alternate between the attractant plume generation state and the capture state. For example, the system 5 can be configured to operate using a 10% duty cycle (i.e., the system 5 is operated in the capture state 10% of the time).

The system 5 can also include further insect attractant means. For example, the system 5 can be configured to include ultrasonic generators configured to emit ultrasonic waves that appeal to insects or lasers configured to emit coherent light that appeals to insects. The system 5 can also include electrostatic attractant means configured to generate sound signals having one or more frequencies similar to that emitted by insects during mating season and/or other desirable frequencies.

The system 5 can be configured to be powered using multiple power sources. For example, the system 5 can be configured to be connected to an AC power source (e.g., household power), a DC power source (e.g., a vehicle electrical system), a battery, a thermoelectric generator, a hand-crank power generator, a solar panel, a dynamo, chemical-electric power generation, etc.

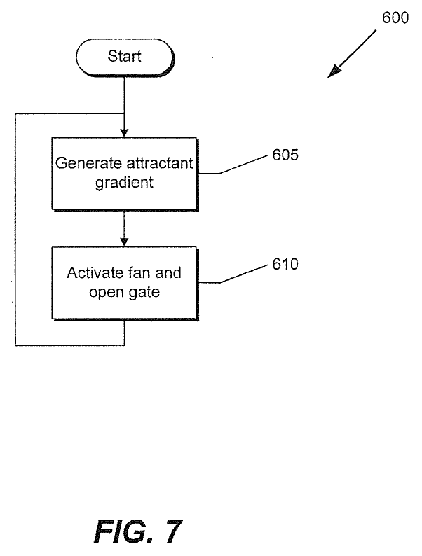

In operation, referring to FIG. 7, with further reference to FIGS. 1A, 1B, 2A and 2B, a process 600 for capturing insects using the system 5 includes the stages shown. The process 600, however, is exemplary only and not limiting. The process 600 may be altered, e.g., by having stages added, removed, or rearranged.

At stage 605, the system 5 generates the attractant plume. The processor 40 causes the fan 15 stop, and causes the gate 35 to sealably engage the housing 15. The system 5 generates an attractant plume using the insect attract in the attractant chamber 35. The attractant chamber 35 converts the fuel into carbon dioxide using a catalytic combustion process. The attractant chamber 35 controls the release of the carbon dioxide and the attractant, although other configurations are possible (e.g., the attractant can be a time-release block). The attractant plume forms an airborne attractant zone in the vicinity of the attractant chamber 35 (e.g., as indicated by arrows 50 in FIG. 2A). Preferably, as the attractant plume is generated, insects begin to gather around the attractant chamber 35. The attractant zone is generated such that it is substantially within the capture zone. The process 600 remains in stage 605 for a predetermined amount of time (e.g., ten minutes).

At stage 610, the system 5 captures the insects gathered in the capture zone. The processor 40 causes the fan 15 to engage, and the gate 30 to disengage the housing 10. The fan 15 causes an air current (e.g., as indicated by arrows 60 in FIG. 2B) that draws the insects within the capture zone into the housing 10 and into the trapping device 20. The processor 600 remains in stage 610 for a predetermined amount of time (e.g., about five seconds).

In another embodiment, the insect trap includes a gate that is fixed in such a position as to allow air to flow into the housing 10 and into trapping device 20. The fan 15 is operated periodically or intermittently: when the fan 15 is off, insects are attracted to the attractant chamber 35; when the fan 15 is on, the insects that have gathered in the attractant zone are forced into the housing 10 and the capture zone 20 by the air current. In an alternative embodiment, there is no gate at all, and the portion of the housing closest to the attractant chamber is configured to channel the air current generated by the fan into the trapping zone.

Other embodiments are within the following claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. An insect trap system comprising:
a housing having first and second opposing ends, the first opposing end defining an aperture;
an insect attractant module configured to create an airborne attractant zone;
a fan disposed and configured to draw air into the housing through the aperture; and
a gate configured to operate in a first state wherein airflow through the aperture is inhibited by the gate, and to operate in a second state wherein airflow through the aperture is not substantially inhibited by the gate,
wherein the gate is maintained in the first state for a predetermined first time such that the airborne attractant zone is formed and the gate is maintained in the second state for a second predetermined time such that insects within a capture zone are compelled to enter the housing through the aperture,
wherein the gate is configured to alternate between the first and second states.

2. The insect trap of claim 1, wherein the housing is configured to act as a visual attractant for insects.

3. The insect trap of claim 1 further comprising a trapping device within the housing.

4. The insect trap of claim 3, wherein the trapping device is a net, the net being configured to catch insects when the gate is in the second state.

5. The insect trap of claim 3, wherein the trapping device is an electrical discharge device, the electrical discharge device being configured to kill insects when the gate is in the second state.

6. The insect trap of claim 3 further comprising a funnel disposed between the gate and the trapping device, the funnel defining a narrow end, the narrow end opening into the trapping device, an air current through the narrow end when the gate is in the second state being sufficient to prevent insects from escaping from the housing.

7. The insect trap of claim 1, wherein the airborne attractant zone comprises at least one of carbon dioxide and a lure.

8. The insect trap of claim 7, wherein the carbon dioxide is generated by a catalytic combustion process.

9. The insect trap of claim 7, wherein the lure comprises at least one of Octenol, Lurex3®, brevicomin, codlelure, cue-lure, disparlure, dominicalure, eugenol, frontalin, gossyplure, grandlure, hexalure, ipsdienol, ipsenol, japonilure, lineatin, litlure, looplure, medlure, megatomoic acid, methyl eugenol, α-multistriatin, muscalure, orfralure, oryctalure, ostramone, siglure, sulcatol, trimedlure, trunc-call, lactic acid, and a salt of lactic acid.

10. The insect trap of claim 1, further comprising a processor, the processor being configured to execute instructions that cause the insect trap to alternate between an attractant plume generation state and a capture state.

11. The insect trap of claim 10, wherein the attractant plume generation state comprises the fan being in an off position, the gate being in the first state, and the attractant module generating an attractant plume.

12. The insect trap of claim 10, wherein the capture state comprises the fan being in an on position, the gate being in the second state, and the attractant module optionally generating an attractant plume.

13. The insect trap of claim 1, wherein the insect attractant module includes at least one of an ultrasonic generator, electrostatic sound generator, and a laser.

14. A method of trapping insects comprising:
A. providing a housing having first and second opposing ends, the first opposing end defining an aperture;
B. providing a gate, an airflow through the aperture being inhibited when the gate is in a closed position and uninhibited when the gate is in an open position;
C. closing the gate and producing insect attractants in an insect attractant zone adjacent to the aperture for a first predetermined time; and
D. after the first predetermined time, and for a second predetermined time, opening the gate and drawing air into the housing through the aperture by means of a fan, wherein the airflow in the aperture is such that insects within the aperture and within an adjacent capture zone are drawn into the housing through the aperture.

15. The method of claim 14, further comprising providing a processor configured to cause steps to repeat steps C and D in a continuous sequence.

16. The method of claim 14 further comprising trapping insects that are drawn into the housing with at least one of a net and an electric discharge device disposed within the housing.

17. The method of claim 14, further comprising providing a trapping device within the housing, and a funnel disposed between the aperture and the trapping device, a narrow end of the funnel opening into the trapping device, the funnel being configured such that when the fan draws air into the housing, an air current at the narrow end of the funnel is sufficient to inhibit insects from escaping from the housing.

18. The method of claim 14, wherein the airborne insect attractants are at least one of carbon dioxide and a lure.

19. The method of claim 18, wherein the carbon dioxide is generated by a catalytic combustion process.

20. The method of claim 14, wherein the insect attractant attractants include at least one of an ultrasonic generator, electrostatic sound generator, and a laser.

21. An insect trap system comprising:
a housing having first and second opposing ends, the first opposing end defining an aperture;
an insect attractant module configured to create an airborne attractant zone;
a fan disposed and configured to draw air into the housing through the aperture; and
wherein the fan is maintained in a first state for a predetermined first time such that the airborne attractant zone is formed and the fan is maintained in the second state for a second predetermined time such that insects within a capture zone are compelled to enter the housing through the aperture,
wherein the fan is configured to alternate between the first and second states.

22. The insect trap of claim 21, wherein the fan is in an off position in the first state and is in an on position in the second state.
